(19) United States
(12) Patent Application Publication
(10) Pub. No.: US 2008/0129929 A1
(43) Pub. Date: Jun. 5, 2008

(54) Display Apparatus and Display Element

(76) Inventors: Koichi Miyachi, Kyoto (JP); Takako Koide, Nara (JP)

Correspondence Address: NIXON & VANDERHYE, PC, 901 NORTH GLEBE ROAD, 11TH FLOOR, ARLINGTON, VA, 22203, US

(21) Appl. No.: 10/585,865

(22) PCT Filed: Jan. 19, 2005
(86) PCT No.: PCT/JP05/00944

§ 371 Date: Jul. 11, 2006

(30) Foreign Application Priority Data
Jan. 19, 2004 (JP) 2004-011207

(51) Int. Cl. G02F 1/1333

(52) U.S. Cl. 349/89

(57) ABSTRACT

RGB colors are displayed with the same gradation by applying different voltages to display elements in pixels (7). This is in turn done by, for example, either producing a different reference voltage for each RGB color in a reference voltage generating circuit (8) or making reference to a LUT stored in a memory section (15). Hence, color discrepancies in a display element can be effectively limited.

### TECHNICAL FIELD

The present invention relates to a display apparatus and element capable of accurate color reproduction both when the display apparatus is viewed at right angles and when the apparatus is viewed from an oblique angle.

### BACKGROUND ART

Among various display elements, the liquid crystal display element is thin, lightweight, and low in power consumption. Liquid crystal display elements have a wide range of applications including television, video, and computer monitors, as well as in word processors, personal computers, and like office automation equipment.

For example, a conventional, commercialized liquid crystal display element utilizes a nematic liquid crystal and operates in twisted nematic (TN) mode. This type of liquid crystal display element however has disadvantages: e.g., it is slow to respond and has a narrow range of viewing angles.

Some liquid crystal display elements operate in display modes where a ferroelectric liquid crystal (FLC) or an anti-ferroelectric liquid crystal (AFLC) is utilized. These liquid crystal display elements are quick to respond and have a wide range of viewing angles. They however have such serious disadvantages in resistance to external forces, temperature characteristics, etc. that they have not found wide applications.

Polymer dispersion liquid crystal display elements utilizing light scattering need no polarizer and are capable of producing a display with high brightness. However, the polymer dispersion liquid crystal display element has problems in response characteristics in reproducing images. The element is hardly better than the TN-mode liquid crystal display element.

The foregoing display elements exploit the rotation of molecules in an electric field. In contrast to them, those display elements which make use of substances which change optical anisotropy in an electric field are suggested. Especially notable are those based on a substance showing electronic polarization or orientational polarization due to electro-optic effects.

Electro-optic effects refer to a phenomenon in which the refractive index of a substance changes in an external applied electric field. The Pockels effect is an electro-optic effect in which the refractive index of a substance is in proportion to the electric field. The Kerr effect is another electro-optic effect in which the refractive index of a substance is in proportion to the electric field raised to the second power.

Especially, substances which show the Kerr effect have long been applied to high speed optical shutters. Such substances have also found practical applications in special measuring equipment. The Kerr effect was discovered by J. Kerr in 1875. The refractive index of a substance which shows the Kerr effect is in proportion to an applied electric field raised to the second power. Therefore, when used for orientational polarization, the substance showing the Kerr effect is expected to be driven at lower voltage than the substance showing the Pockels effect. Further, the substance showing the Kerr effect responds in a few microseconds to a few milliseconds. It is thus expected that the substance will be used to achieve a quick display in response to an input voltage in a display apparatus.

Conventionally known materials showing the Kerr effect include nitrobenzene and carbon bisulfide. These materials were used to measure a strong electric field produced by, for example, an electric power cable. Later, it was discovered that the liquid crystal material also show the Kerr effect, which prompted basic studies for applications in optical modulation elements, optical polarizer elements, and optical integrated circuits. There is also a report about a liquid crystal compound which has a Kerr constant over 200 times that of nitrobenzene.

In this general context, many studies have recently started on applications of substances which show the electro-optic effect in proportion to the electric field raised to the second power (hereinafter, the “Kerr effect”). Many of the studies are geared to produce a display element based on a substance which changes optical anisotropy in an applied electric field.

### DISCLOSURE OF INVENTION

A voltage-transmittance curve is shown in FIG. 10(a). The graph was obtained from a display element built based on a substance which changes optical anisotropy under applied voltage. The element is equipped with R (red), G (green), B (blue) filters. The transmittances in FIG. 10(a) were measured supposing that the display element was viewed at right angles, that is, from the normal to the display element substrate. As can be seen from the figure, the transmittance level for identical voltages varies among R, G, and B.

The substance which changes optical anisotropy chosen for the measurement was the substance of formula 1 (detailed later), that is, 4-cyano-4′-n-pentylbipentyl. A similar curve to the one in FIG. 10(a) is obtainable from a substance which is optically isotropic in the absence of applied voltage and becomes anisotropic under applied voltage and which also meets the following condition:

n(R)/λ(R)<n(G)/λ(G)<n(B)/λ(B)

where λ(R), λ(G), and λ(B) are the middle wavelengths for R, G, and B (typically about 650 nm, 550 nm, and 450 nm respectively), and n(R), n(G), and n(B) are the refractive indices of the substance at those wavelengths.

FIG. 10(b) shows the ratios of the transmittances for R and B light to that for G light at various voltages. As can be seen from FIG. 10(b), the ratios do not match throughout the voltage range. This fact leads to a problem in producing color gradation displays on the display element based on a substance which changes optical anisotropy under applied voltage. Colors are not accurately displayed if R, G, and B pixels are driven at a common gradation voltage. In the following, this phenomenon where accurate color display is not feasible will be referred to as the “occurrence of color discrepancy.”

The present invention, conceived to address the conventional problems, has an objective to provide a display apparatus and element which are capable of effectively limiting the color discrepancies.

A display apparatus of the present invention, to address the problems, contains display elements including a medium injected and sealed between a pair of substrates at least one of which is transparent. The medium changes in magnitude of optical anisotropy upon application of voltage. Each of the display elements contains colors required to produce a color image display, so as to produce a color image display. Different voltages are applied to the display elements so as to display the colors required to produce a color image display with an identical gradation.

In other words, the medium used in the display element in the display apparatus of the present invention changes its optical anisotropy upon application of voltage. The optical anisotropy has a wavelength dispersion characteristic where it varies depending on wavelength. Therefore, when colors required to produce a color image display (for example, the there, RGB, colors) need to be displayed with an identical gradation, if the same voltages are applied to the display elements, the colors are not accurately displayed. This phenomenon is termed “color discrepancies.”

Accordingly, in the present invention, when colors required to produce a color image display need to be displayed with an identical gradation, different voltages are applied to the display elements. Therefore, voltages can be applied to the display elements in accordance with the wavelength dispersion characteristic of the optical anisotropy. The color discrepancies can be thus limited.

Especially, the medium only changes in magnitude of optical anisotropy. The application voltage vs. transmittance relationship of the display element practically matches up for two cases: i.e., when the display element is viewed normal to the substrate and when the display element is viewed from an acute angle with respect to the normal. Therefore, in both cases, color discrepancies are limited, and colors are accurately displayed.

Additional objects, advantages and novel features of the invention will be set forth in part in the description which follows, and in part will become apparent to those skilled in the art upon examination of the following or may be learned by practice of the invention.

### BRIEF DESCRIPTION OF DRAWINGS

FIG. 1 is a block diagram of a structure of an embodiment of the display apparatus in accordance with the present invention.

FIG. 2 is a schematic diagram of a structure of and around a display element in the display apparatus of FIG. 1.

FIG. 3(a) is a cross-sectional view of the display element of FIG. 2 in the absence of applied voltage, and FIG. 3(b) is a cross-sectional view of the display element of FIG. 2 under applied voltage.

FIG. 4 is a schematic drawing illustrating in detail a structure of electrodes in the display element of FIG. 2.

FIG. 5(a) is a cross-sectional view of the display element of FIG. 2 in the absence of applied voltage, FIG. 5(b) is a cross-sectional view of the display element under applied voltage, and FIG. 5(c) is graph showing the application voltage vs. transmittance for the display element.

FIG. 6 is a drawing illustrating differences in display principles between the display element in the display apparatus of FIG. 1 and conventional liquid crystal display elements.

FIG. 7 is a schematic drawing showing a structure of liquid crystal microemulsion.

FIG. 8 is a schematic drawing showing a structure of liquid crystal microemulsion.

FIG. 9 is a schematic drawing showing a structure of liquid crystal microemulsion.

FIG. 10(a) is a graph showing the application voltage vs. transmittance for the display element of FIG. 2 for each R, G, and B color, and FIG. 10(b) is a graph showing the ratios of the transmittances for R and B light to that for G light at various voltages.

### BEST MODE FOR CARRYING OUT THE INVENTION

The following will describe an embodiment of the present invention in reference to figures.

### [1. Structure and Display Principles of Display Element]

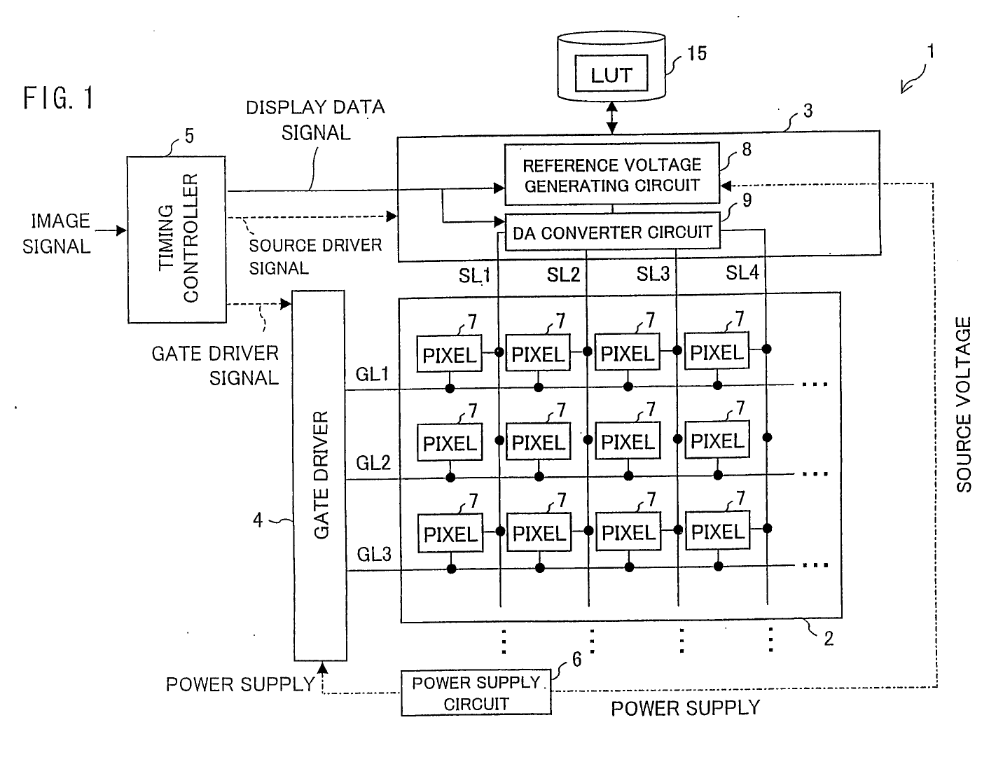

First, the structure of a display apparatus built based on display elements in accordance with the present embodiment will be described. Referring to FIG. 1, the display apparatus 1 in accordance with the present embodiment contains: a display panel 2 provided with a matrix of pixels each containing a display element constructed as will be detailed later; a source driver 3 driving data signal lines SL1 to SLn on the display panel 2; a gate driver 4 driving scan signal lines GL1 to GLm on the display panel 2; a timing controller 5; and a power supply circuit 6 supplying voltage to a source driver 3 and a gate driver 4 for display on the display panel 2.

The timing controller 5 feeds the source driver 3 with digitized display data signals (for example, RGB video signals representing red, green, and blue) and source driver control signals controlling the operation of the source driver 3. The controller 5 also feeds the gate driver 4 with gate driver control signals controlling the operation of the gate driver 4. The source driver control signals include a horizontal synchronization signal, a start pulse signal, and a source driver clock signal. In contrast, the gate driver control signals include a vertical synchronization signal and a gate driver clock signal. Based on an externally fed video signal, the timing controller 5 determines the display data signals fed to the source driver 3.

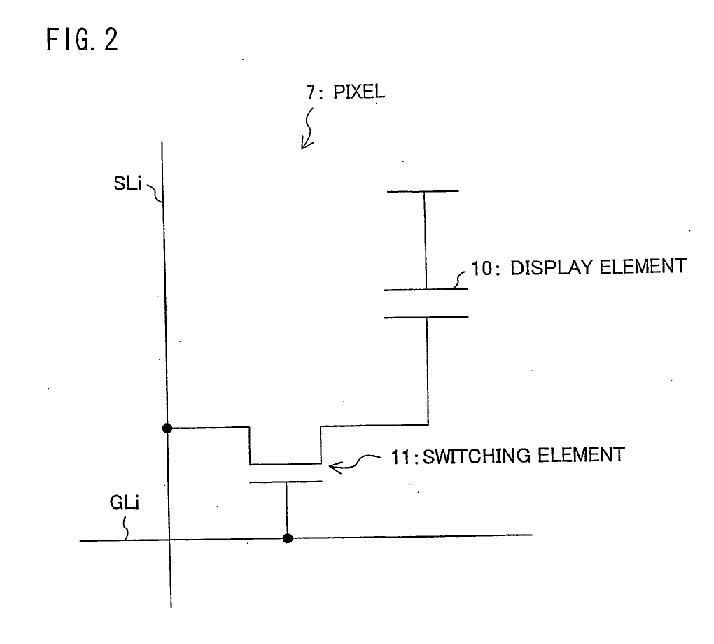

The display panel 2 has the data signal lines SL1 to SLn and the scan signal lines GL1 to GLm crossing the data signal lines SL1 to SLn. A pixel 7 is provided to each intersection of the data signal lines and the scan signal lines. As shown in FIG. 2, each pixel 7 includes a display element 10 and a switching element 11. The structure of the display element 10 will be described later in detail.

In the pixel 7, selecting the scan signal line GLj turns on the switching element 11, allowing signal voltage determined based on the display data signals from the timing controller 5 to be applied by the source driver 3 to the display element 10 via the data signal line SLi. Then, the scan signal line GLj is deselected to turn off the switching element 11, theoretically causing the display element to retain the voltage at the turn off.

The transmittance or reflectance of the display element 10 changes with the signal voltage applied to the switching element 11. Therefore, the display gradation of the pixel 7 can be varied according to video data by selecting the scan signal line GLj and applying a signal voltage from the source driver 3 to the data signal line SLi in accordance with the display data signals for the pixel 7. Since the pixel 7 has color filters of different colors, for example, RGB colors, a color image display is produced on the display panel 2.

The signal voltage is produced by a reference voltage generating circuit 8 and a DA converter circuit 9 in the source driver 3. In other words, based on a power voltage from the power supply circuit 6, the reference voltage generating circuit 8 produces various analog voltages for a gradation display and outputs to the DA converter circuit 9.

Meanwhile, the DA converter circuit 9 selects an analog voltage in accordance with the display data signals representing digital data from the various analog voltages supplied from the reference voltage generating circuit 8. The selected analog voltage representing a gradation display is output as a signal voltage to the data signal line SLi.

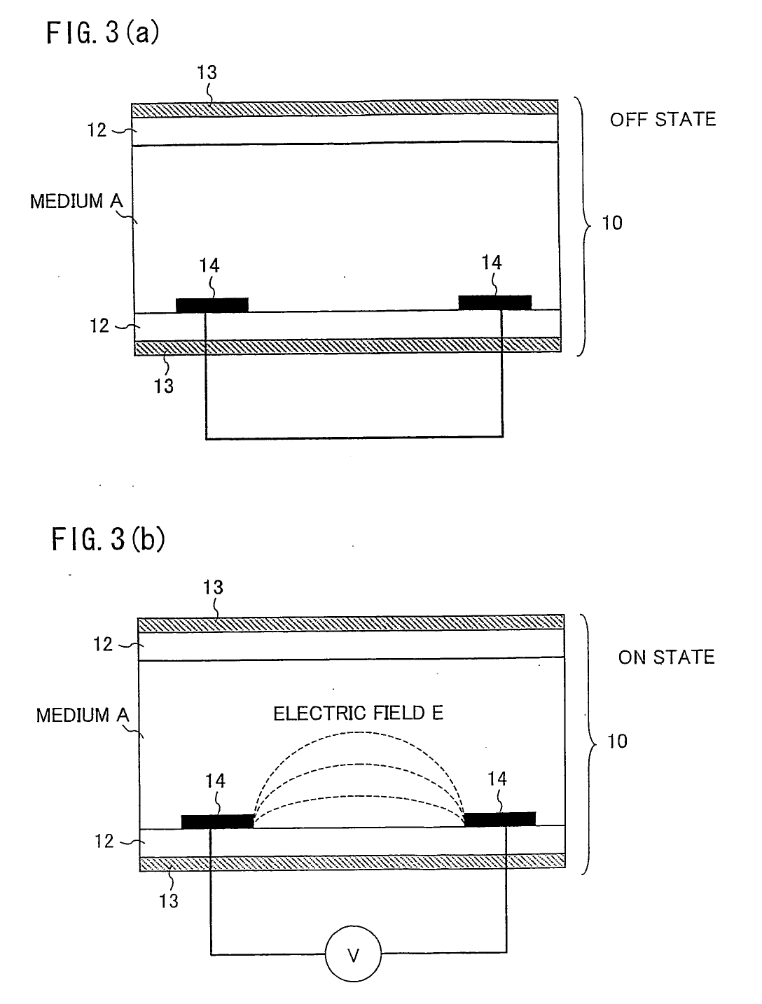

FIG. 3 is a detailed cross-sectional view of the structure of the display element 10. As shown in FIG. 3(a), the display element 10 contains two glass substrates 12 positioned opposite to each other and polarizers 13 positioned outside the glass substrates 12. A medium is injected and sealed in the display element 10 between the two glass substrates 12. The medium (hereinafter, simply the “medium A”) changes its own anisotropy or orientational order under applied voltage. The thickness of the medium A is specified to, for example, about 10 μm. The medium A is nematic below 33.3° C. and isotropic at or above that temperature. The medium A may be, for example, the substance set forth by chemical formula 1:

### Chemical formula 1:

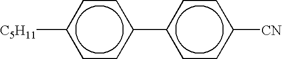

### Other concrete examples of the medium A will be detailed later.

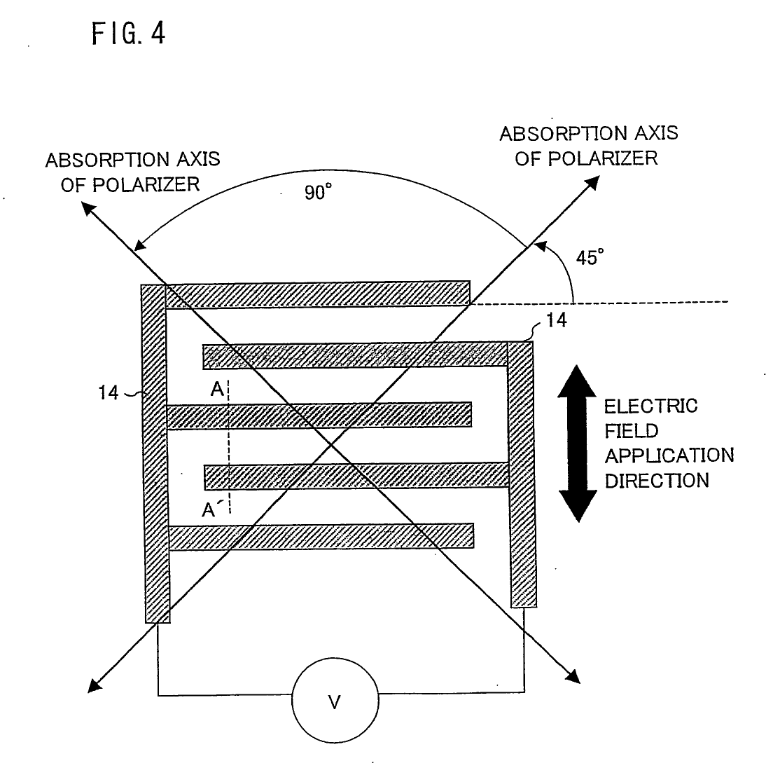

Two electrodes 14 are formed opposite to each other on a surface of one of the glass substrates 12. Specifically, as shown in FIG. 4, both electrodes 14 are shaped like comb teeth and so positioned that the teeth of one of the them can engage with those of the other. The width of the electrodes 14 is specified to 5 μm. The distance between two electrodes 14 is specified to 5 μm. The width and the distance are not limited to these values. They may be specified to any given values, for example, in accordance with a gap between the two substrates 12. The electrodes 14 are made of, for example, ITO (indium tin oxide) or another transparent electrode material; aluminum or another metal electrode material; or one of a wide variety of publicly known electrode materials.

Still referring to FIG. 4, the polarizers provided on the respective substrates are so positioned that their absorption axes can be orthogonal and form an about 45° angle with respect to the direction in which the comb teeth of the electrodes 14 extend. As a result, the absorption axes of the polarizers form an about 45° angle with respect to an electric field application direction for the electrodes 14.

With the electrodes 14 thus positioned, an electric field develops substantially parallel to the substrate 12 when voltage is applied to the electrodes 14 as shown in FIG. 3(b). Whilst the display element thus constructed is being maintained, using a heater, at a temperature close to that at which the medium A switches between nematic phase and isotropic phase (a little higher than the phase change temperature, for example, +0.1 K), the transmittance can be changed upon the application of voltage to the electrodes 14.

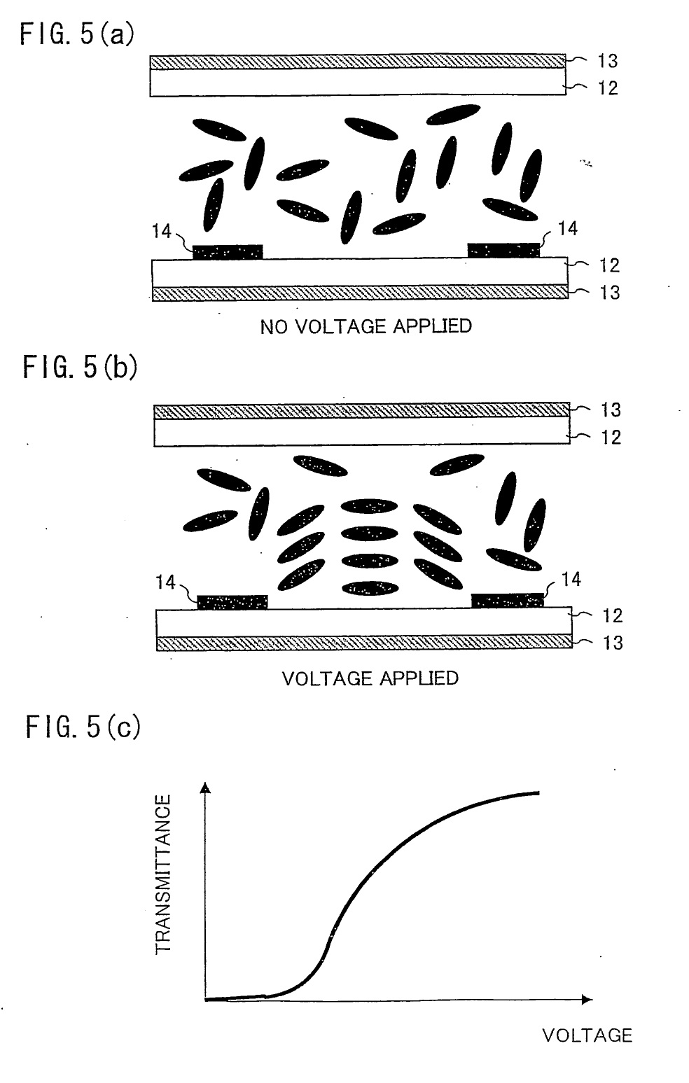

Next, the image display principles of the display element in accordance with the present embodiment will be described in reference to FIG. 5. As shown in FIG. 5(a), with no voltage being to applied to the electrodes 14, the medium A between the substrates 12 are in its isotropic phase and are optically isotropic; the display element hence appears black.

Referring now to FIG. 5(b), when a voltage is being applied to the electrodes 14, the medium A molecules point so that their long axes align with the electric field over the electrodes 14, entailing a birefringence phenomenon. The birefringence phenomenon in turn allows for modulation of the transmittance of the display element in accordance with the voltage across the electrodes as shown in FIG. 5(c).

Incidentally, if the temperature of the display element increasingly differs from the phase change temperature of the medium A, a higher voltage is needed to modulate the transmittance of the display element. In contrast, if the temperature of the display element closely matches with the phase change temperature of the medium A, applying a voltage of about 0 V to 100 V to the electrodes 14 will sufficiently modulate the transmittance of the display element.

### [2. Other Examples of Structure of Display Element]

In the present display element, the medium A may be 4′-n-alkoxy-3′-nitrobiphenyl-4-carboxylic acids (ANBC-22) which is a transparent dielectric substance.

The substrates 12 were made of glass. Beads were scattered in advance to maintain the distance between the substrates at 4 μm. That is, the thickness of the medium A was specified to 4 μm.

The electrodes 14 were transparent electrodes made of ITO. An alignment film of polyimide was formed on each of the internal surfaces (opposing planes) of the substrates and subjected to a rubbing process. The rubbing direction is preferably such that the element could be in a bright state in a smectic C phase. Typically, it is desirable if the rubbing direction differs from the axis of the polarizer by 45°. Incidentally, the alignment film on one of the substrates 12 was formed to cover the electrodes 14.

The polarizers 13, as shown in FIG. 4, are so positioned outside the respective substrates 12 (on the side other than the opposing plane) that their absorption axes can be orthogonal and form an about 45° angle with respect to the direction in which the comb teeth of the electrodes 14 extend.

The display element thus constructed is in a smectic C phase below the phase change temperature between a smectic C phase and a cubic phase. In the smectic C phase, the medium A exhibits optical anisotropy in the absence of applied voltage.

Whilst the display element was being maintained, using an external heater, at a temperature close to that at which the medium A switched between smectic C phase and cubic phase (at or up to about 10 K below the phase change temperature), the transmittance could be changed upon the application of voltage (about 50 V AC electric field (more than 0 Hz up to about a few hundreds kHz). In other words, the optically anisotropic smectic C phase (a bright state) in the absence of applied voltage changed to the isotropic cubic phase (dark state) upon the application of voltage.

The angle formed by the absorption axes of the polarizers and the comb-shaped electrodes was not limited to 45°. Displays were possible at any angle between 0° to 90°, for the following reason. The bright state was realized in the absence of an electric field. Whether the bright state was feasible or not depended solely on the relationship between the rubbing direction and the direction of the absorption axes of the polarizers. Further, the dark state was realized by means of the medium phase change to an optical isotropic phase induced by the application of an electric field. The dark state was achieved as long as the absorption axes of the polarizers were orthogonal. The direction of the comb-shaped electrodes was irrelevant. Therefore, no alignment process was required. Displays were possible even in amorphous alignment (random alignment).

Now, each substrate 12 was provided with an electrode to produce an electric field normal to the substrates. Substantially the same results were obtained from these substrates. In other words, substantially the same results were obtained with an electric field parallel to the substrate as with an electric field normal to the substrates.

As could be understood from the foregoing, the medium A in the present display element may be any medium which is optically anisotropic in the absence of an electric field, but loses the optical anisotropy and exhibits optical isotropy under applied voltage.

Further, the medium A in the present display element may have positive dielectric anisotropy or negative dielectric anisotropy. If the medium A has positive dielectric anisotropy, the medium A needs be driven with an electric field substantially parallel to the substrates. This does not apply if the medium A has negative dielectric anisotropy.

In the latter case, the medium A may be driven, for example, with an electric field perpendicular or oblique to the substrates. To achieve this, an electrode is given to each of the paired substrates (substrates 12) which are oppositely positioned. An electric field is produced between the electrodes on the respective substrates and applied across the medium A.

Regardless of whether the applied electric field is parallel, perpendicular, or oblique to the substrate plane, the electrodes may be altered in shape, material, number, and layout in a suitable manner. For example, applying an electric field perpendicular to the substrate plane by the use of transparent electrodes is advantageous in terms of aperture ratio.

### [3. Differences of Display Element of Present Embodiment Over Existing Liquid Crystal Display Elements]

Next, differences in display principles between the display element 10 of the present embodiment and conventional liquid crystal display elements will be described in more detail.

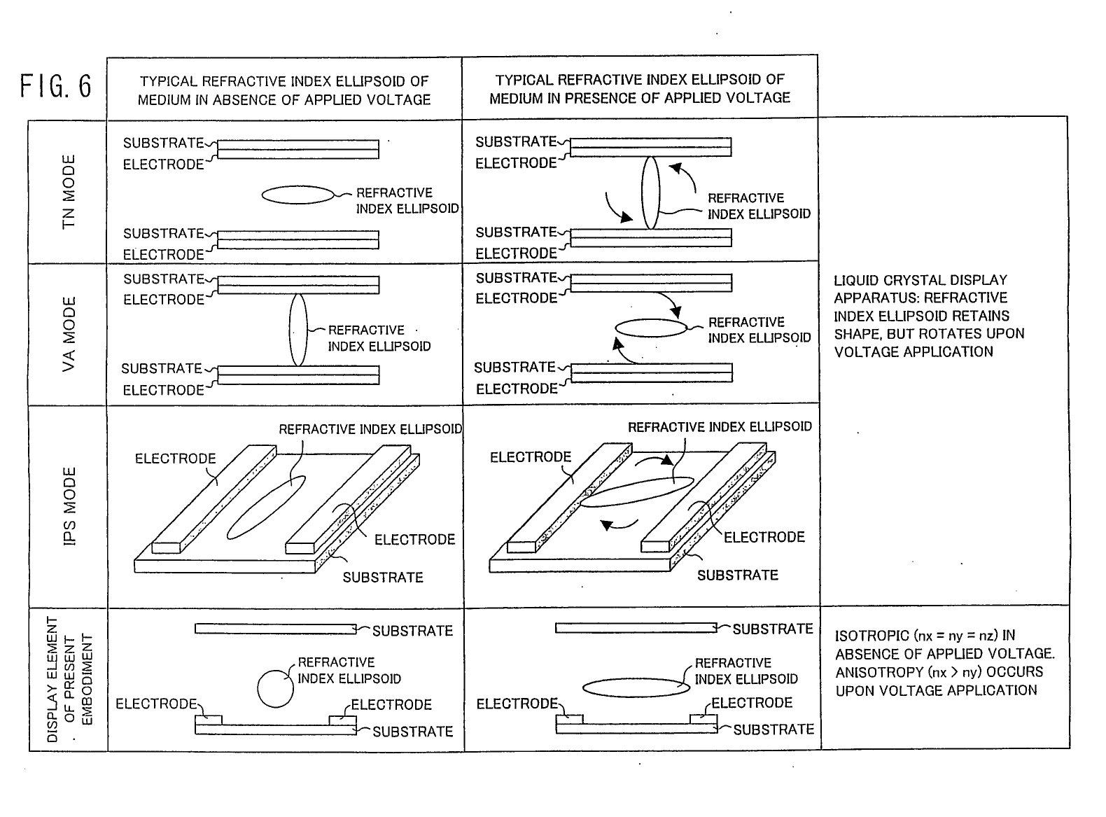

FIG. 6 is an illustration explaining differences in display principles between the present display element and conventional liquid crystal display elements. The shape and direction of a refractive index ellipsoid is schematically shown in the presence and absence of applied voltage. Conventional liquid crystal display elements included in FIG. 6 are of TN mode, VA (vertical alignment) mode, or IPS (in-plane switching) mode.

As shown in the figure, the TN liquid crystal display element contains a liquid crystal layer sandwiched between opposite substrates. It also contains transparent electrodes (electrodes), one on each substrate. In the absence of applied voltage, the liquid crystal molecules in the liquid crystal layer align so that their long axes are twisted, or chiral. The molecules, under applied voltage, however, align so that their long axes are parallel to the electric field.

A typical refractive index ellipsoid in such a case is shown in FIG. 6. The long axes point parallel to the substrate plane in the absence of applied voltage and normal to the substrate plane under applied voltage. In other words, the refractive index ellipsoid retains the same shape whether or not the ellipsoid is under applied voltage. The ellipsoid only changes its direction (rotates) depending on the presence/absence of applied voltage.

Similarly to TN mode, the VA liquid crystal display element contains a liquid crystal layer sandwiched between opposite substrates. It also contains transparent electrodes (electrodes), one on each substrate. In the VA liquid crystal display element, however, when no voltage is being applied, the liquid crystal molecules in the liquid crystal layer align so that their long axes are substantially normal to the substrate plane. The molecules, under applied voltage, align so that their long axes are perpendicular to the electric field.

A typical refractive index ellipsoid in such a case is shown in FIG. 6. The long axes point normal to the substrate plane in the absence of applied voltage and parallel to the substrate plane under applied voltage. In other words, the refractive index ellipsoid retains the same shape whether or not the ellipsoid is under applied voltage. The ellipsoid only changes its direction depending on the presence/absence of applied voltage.

The IPS liquid crystal display element contains a pair of electrodes on one of the substrates. The electrodes are positioned opposite each other. A liquid crystal layer is provided between the electrodes. The alignment direction of the liquid crystal molecules changes with applied voltage, so that different display states occur depending on the presence/absence of applied voltage. Therefore, in the IPS liquid crystal display element, the refractive index ellipsoid again retains the same shape whether or not the ellipsoid is under applied voltage. Again, see FIG. 6. The ellipsoid only changes its direction depending on the presence/absence of applied voltage.

As could be understood from the foregoing, the liquid crystal molecules in conventional liquid crystal display elements align, pointing a certain direction, even in the absence of applied voltage. The alignment direction changes with applied voltage. The conventional element exploits the change to produce displays (modulates the transmittance). In other words, the refractive index ellipsoid retains its shape, but rotates (changes its direction) with applied voltage, so as to produce displays. To put it differently, in the conventional liquid crystal display element, the liquid crystal molecules have a constant orientational order parameter, but change its alignment direction, so as to produce displays.

In contrast, as to the display element 10 in accordance with the present embodiment, the refractive index ellipsoid is spherical in the absence of applied voltage as shown in FIG. 6. In other words, the display element 10 is isotropic in the absence of applied voltage (orientational order parameter=0). The display element 10 becomes anisotropic upon the application of voltage (orientational order parameter>0). In other words, in the display element 10 in accordance with the present embodiment, the shape of the refractive index ellipsoid is isotropic (nx=ny=nz) in the absence of applied voltage. As a voltage is applied, the shape of the refractive index ellipsoid comes to indicate anisotropy (nx>ny). Note that nx is a refractive index parallel to the substrate plane and also to the direction in which the electrodes oppose each other, ny is a refractive index parallel to the substrate plane, but perpendicular to the direction in which the electrodes oppose each other, and m/z is a refractive index perpendicular to the substrate plane.

In short, in the display element 10 in accordance with the present embodiment, the medium changes its magnitude of optical anisotropy. This change is represented by changes in shape and size of the refractive index ellipsoid which occur upon the application of voltage. Therefore, the long axis of the refractive index ellipsoid of the display element 10 in accordance with the present embodiment is either parallel or perpendicular to the electric field.

In contrast, as to the conventional liquid crystal display element, the refractive index ellipsoid retains its shape and size, whilst the long axis of the refractive index ellipsoid rotates, to produce displays. The orientational order parameter is therefore substantially constant.

As could be understood from the foregoing, in the display element 10 in accordance with the present embodiment, provided that the voltage application direction is constant, the optical anisotropy direction is constant, but the orientational order parameter is modulated to produce displays. In other words, in the display element 10 in accordance with the present embodiment, the anisotropy (or orientational order) of the medium itself changes. Therefore, the display element 10 in accordance with the present embodiment differs greatly in display principles from the conventional liquid crystal display element.

### [4. Method of Specifying Gradation Voltage Values in Present Embodiment]

The inventors studied color discrepancies in conventional art for their causes. The studies revealed that the conventional art problems were caused by the wavelength dispersion characteristic of the optical anisotropy: the optical anisotropy, which occurred to the medium A upon the application of voltage, varied depending on wavelength.

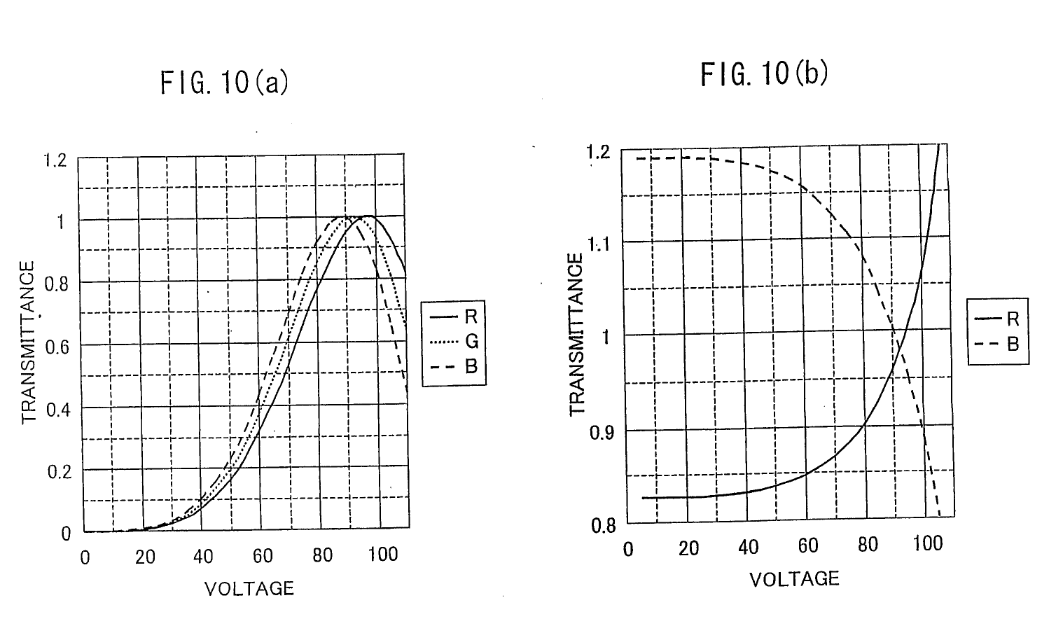

In other words, as shown in FIG. 10(b), the transmittance for R, G, and B does not match at given voltages. No achromatic color can be reproduced. Achromatic color may be achievable for only one voltage value, for example, by differing aperture ratios for R, G, B pixels or differing color intensities for the color filters. However, since the transmittance for R, G, and B varies with voltage as mentioned earlier, this approach cannot correct for color discrepancies at all voltage values. Accordingly, voltage should be corrected optimally for each gradation and for each of the RGB colors. This method will achieve a satisfactory color display for all gradations.

As could be understood from the foregoing, a different gradation voltage value needs be specified for each of the RGB colors to prevent color discrepancies. In other words, to reproduce the RGB colors with the same gradation, the RGB signal voltages need to have different values. The following will describe two example methods to produce different signal voltage values.

### (4-1) RGB Reference Voltages Set to Different Values

In a first example, the reference voltages are set to different values between the RGB colors, so as to reproduce the RGB colors with the same gradation. The reference voltages are fed as various analog voltages for a gradation display, from the reference voltage generating circuit 8 to the DA converter circuit 9. These settings allow those signal voltages which differ between the three RGB colors to be fed from the DA converter circuit 9 to the data signal line SLi for the reproduction of the RGB colors with the same gradation.

Specifically, one would understand from FIG. 10(a) and FIG. 10(b) that the RGB signal voltages needed to achieve the same transmittance have the following relationship:

(R signal voltage)>(G signal voltage)>(B signal voltage)

The reference voltages produced by the reference voltage generating circuit 8 to reproduce the RGB colors with the same gradation need to satisfy the following relationship:

(R reference voltage)>(G reference voltage)>(B reference voltage)

### Signal voltages from 0 V to about 95 V can achieve from a minimum transmittance (0) to a maximum transmittance (1) for the RGB colors as could be understood from FIG. 10(a).

The reference voltages produced by the reference voltage generating circuit 8 should be set to different values between the RGB colors. To do this, a voltage vs. transmittance curve like the one in FIG. 5(a) is prepared in advance. The values are then set in accordance with the magnitude relationship of the RGB signal voltages shown by the curve.

With this method, the signal voltage values can be specified extremely accurately, enabling highly accurate reproduction of the RGB colors.

### (4-2) RGB Signal Voltage Values Stored in Advance

Next will be described another method whereby signal voltage values which differ between the RGB colors are produced so as to reproduce the RGB colors with the same gradation. A lookup table (LUT) is prepared containing display data signals and associated signal voltage values for each of the RGB colors. As will be detailed later, the signal voltages values contained in the table are such that they can accurately reproduce the gradations represented by the display data signals. The signal voltage values are specified according to the lookup table.

Specifically, referring to FIG. 1, a memory section 15 is provided in the display apparatus 1. The section 15 may be a ROM or other storage medium. The LUT is stored in the memory section 15. Upon the input of a display data signal, the reference voltage generating circuit 8 and the DA converter circuit 9 look for the display data signal in the LUT. Then, the circuits 8, 9 outputs the associated signal voltage that can accurately reproduce the gradation represented by the display data signal onto the data signal line SLi.

It is difficult to generate a lookup table which completely reflects the association between the display data signals and the signal voltage values. This results in discrepancies between the gradations actually reproduced by the pixels 7 and the gradations represented by the display data signals. Some gradations for a color(s) may not be completely corrected.

On the other hand, the signal voltages can be specified to such values that they prevent color discrepancies, by merely adding a ROM, etc. prepared in advance as the memory section 15 to the display apparatus 1. This method is hence advantageous in terms of cost.

In addition, the (4-1) method requires the specification of the reference voltages to different values between the RGB colors. The method also requires associated, additional power supply input terminals for the source driver. These requirements can be translated into increased costs. With these factors considered, the (4-2) method is again advantageous in terms of cost.

### [5. Prevention of Color Discrepancies when Viewed from an Oblique Angle with Respect to Substrate]

The curves in FIG. 10(a) show transmittances when the display element is viewed at right angles, in other words, from the normal to the display element substrate. These curves formed the basis for the aforementioned method whereby the signal voltages are specified to different values between the RGB colors to reproduce the RGB colors with the same gradation. Therefore, the method is effective in limiting color discrepancies which would otherwise occur when the display element is viewed at right angles.

Also, the method is capable of limiting color discrepancies which would otherwise occur when the display element is viewed from an oblique angle with respect to the display element, in other words, from a direction which is at an acute angle with respect to the normal to the display element substrate. Causes for this capability will be described next.

The transmittance, T, of an optical anisotropic medium sandwiched between two orthogonal polarizers in the presence of birefringence is given by equation (1):

T=sin²(2θ)·sin²(δ/2) (1)

where θ is the angle between the transmission axis of one of the two polarizers and the retardation axis of the optical anisotropic medium, and δ is the phase difference created by the optical anisotropic medium.

With θ at 45°, equation (1) is applicable to the display element 10 in accordance with the present embodiment. δ varies from 0° to 180° for the display element 10 in accordance with the present embodiment, because the optical anisotropy of the medium A is changed by the application of voltage. This wavelength dispersion characteristic where the δ varies with wavelength is the cause of the color discrepancy problem with the display element in accordance with the present embodiment.

In the display element 10 in accordance with the present embodiment, the direction in which optical anisotropy occurs is theoretically hardly invariable in the substrate plane. The shape of the voltage-transmittance curve therefore practically matches up for both cases when the display element is viewed from the normal to the element and when it is viewed from an oblique angle with respect to the element. Therefore, the color discrepancies are limited also when the display element is viewed from an oblique angle.

On the other hand, the color discrepancy problem with the aforementioned TN, VA, and IPS liquid crystal display elements cannot be addressed at once for both cases, that is, for right angles viewing and oblique angle viewing, for the following reasons.

### (5-1. TN Liquid Crystal Display Element)

The transmittance of the TN liquid crystal display element cannot be expressed as easily as in equation (1) above. The TN liquid crystal display element basically depends on voltage-induced changes of an angle for gradation displays, the angle being the one between the normal to the substrate and the optical axis of the uniaxial refractive index ellipsoid which represents liquid crystal molecules. Therefore, the shape of the voltage-transmittance curve significantly differs between the two cases: i.e., when the display element is viewed from the normal and when the display element is viewed from an oblique angle. The color discrepancy problem with the TN liquid crystal display element cannot be addressed at once for both cases.

### (5-2. VA Liquid Crystal Display Element)

Equation (1) is applicable to the VA liquid crystal display element, with E being fixed at 45°. δ varies with applied voltage. Theoretically, δ is variable from 0° to 180°. This wavelength dispersion characteristic of the δ of the VA liquid crystal display element is the cause of the color discrepancy problem. Therefore, as with the display element 10 in accordance with the present embodiment, the color discrepancies are indeed correctable by a method whereby the signal voltages are specified to different values between the RGB colors to reproduce the RGB colors with the same gradation.

However, the color discrepancy problem with the VA liquid crystal display element cannot be addressed at once for both cases, i.e., when the display element is viewed from the normal and when the display element is viewed from an oblique angle, because the quantity of the color discrepancy differ between the two cases.

In the VA liquid crystal display element, the liquid crystal molecules in the absence of applied voltage align so that their long axes are normal to the substrate. Upon the application of voltage, the alignment direction moves away from the normal to the substrate. In other words, the optical axis of the uniaxial refractive index ellipsoid is tilted off the normal to the substrate to cause birefringence. The VA liquid crystal display element depends on this birefringence to produce displays. Therefore, in the VA liquid crystal display element, the transmittance significantly varies with the viewing direction. Especially, the transmittance takes either a maximum or minimum value when the viewing angle substantially matches the optical axis or an axis perpendicular to the optical axis.

Therefore, theoretically, in the VA liquid crystal display element, the shape of the voltage-transmittance curve significantly differs between the two cases: i.e., when the display element is viewed from the normal and when the display element is viewed from an oblique angle. The color discrepancy problem with the VA liquid crystal display element cannot be addressed at once for both cases.

### (5-3. IPS Liquid Crystal Display Element)

As to the IPS liquid crystal display element, its optical anisotropic medium has a retardation axis in the substrate plane. The retardation axis rotates around the normal to the substrate under applied voltage. So, equation (1) is applicable to the IPS liquid crystal display element, with δ being a constant. θ varies from 0° to 45°. δ needs be 180° for the transmittance to be a maximum.

Since δ is simply the rotation angle of the optical anisotropic medium, the angle exhibits no wavelength dispersion characteristic which is the cause of the color discrepancy problem. δ does have a wavelength dispersion characteristic, but is constant as mentioned above. Balance between the RGB colors is invariable. A change in gradation does not change the balance between the RGB colors. Therefore, the color discrepancy problem with the IPS liquid crystal display element cannot be addressed at once for both cases: i.e., when the display element is viewed from the normal and when the display element is viewed from an oblique angle.

In the IPS liquid crystal display element, the shape of the voltage-transmittance curve practically matches up for both cases, i.e., when the display element viewed from the normal and when the display element is viewed from an oblique angle, because the optical axis of the uniaxial refractive index ellipsoid is always in the substrate plane unlike the VA liquid crystal display element. The viewing angle therefore hardly affect color discrepancy.

### [6. Medium A—Examples]

As mentioned earlier, the medium A for use in the display element in accordance with the present embodiment is required to change its own anisotropy or orientational order upon the application of voltage. The medium A is not limited to those which exhibit Kerr effect. In other words, any substance may be used as the medium A, provided that either the substance is optically isotropic in the absence of an applied electric field and exhibits optical anisotropy in an applied electric field or the substance is optically anisotropic in the absence of an applied electric field, but loses the optical anisotropy and exhibits optical isotropy in an applied electric field.

The medium A preferably contains a liquid crystalline substance(s). The liquid crystalline substance may singly exhibit liquid crystallinity, or more than one substance may be mixed to achieve liquid crystallinity. Alternatively, another non-liquid crystalline substance may be added to these substances.

An example of such a liquid crystalline substance is given in patent document 1 (Japanese published patent application 2001-249363, or Tokukai 2001-249363; published on Sep. 14, 2001). The substance may be used straightly. Also, the substance may be mixed with a solvent for use as the liquid crystalline substance for inclusion in the medium A. Another example is given in patent document 2 (Japanese published patent application 11-183937/1999, or Tokukaihei 11-183937; published on Jul. 9, 1999). The liquid crystalline substance is divided into small domains. A further example is given in non-patent document 1 (Appl. Phys. Lett., Vol. 69, Jun. 10, 1996, p. 1044). The substance is a polymer-liquid crystal dispersion system.

Anyway, the medium A is preferably optically isotropic in the absence of applied voltage and undergoes optical modulation upon the application of voltage. Typically preferred as the medium A is a substance that improves on the orientational orderliness of molecules or a molecule cluster upon the application of voltage.

Another preferred example of the medium A is a substance that exhibits Kerr effect. A specific example is PLZT (a metal oxide consisting of a solid solution of lead zirconate and lead titanate with added lanthanum), Further, the medium A desirably contains polar molecules. A specific example is nitrobenzene.

The medium A may be chosen from a wide variety of substances. Following are some of the examples.

### (Medium—Example 1)

A first example of the medium A is a smectic D phase (SmD) which is one of liquid crystal phases.

An example of the liquid crystalline substance showing a smectic D phase is ANBC 16. For details about ANBC 16, see non-patent document 2 (Thermodynamics of Optically Isotropic Rare Thermotropic Liquid Crystal by SAITO Kazuya, SORAI Michio, Liquid Crystal, Vol 5, No. 1, pp. 20-27, (2001)), especially p. 21, FIG. 1, Structure 1 (n=16). See also non-patent document 4 (Handbook of Ekisho, Vol. 2B, pp. 887-900, Wiley-VCH, (1998)), especially p. 888, Table 1, Compounds (Nos.) 1, 1a, and 1a-1. The structures of these molecules are shown below.

### Chemical Formula 2:

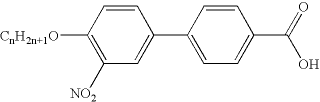

### Chemical Formula 3:

### 4′n-Alkoxy-3′-substituted-biphenyl-4-carboxylic acids

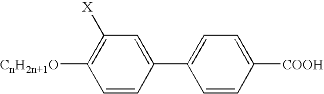

The liquid crystalline substance (ANBC 16) exhibits a smectic D phase at 171.0° C. to 197.2° C. In the smectic D phase, multiple molecules form a three-dimensional lattice like a jungle gym (registered trademark). Its lattice constant is less than or equal to optical wavelengths. In other words, the smectic D phase has an ordered structure in which the molecular arrangement shows cubic symmetry. The smectic D phase therefore is optically isotropic.

ANBC 16 molecules have dielectric anisotropy. Therefore, in an electric field and at temperatures at which ANBC 16 is in a smectic D phase, the ANBC 16 molecules experience forces parallel to the electric field, distorting the lattice structure. In other words, the ANBC 16 exhibits optical anisotropy.

Therefore, ANBC 16 can be used as the medium A in the present display element. The medium A is by no means limited to ANBC 16. Any substance may be used as the medium A in the present display element, provided that the substance shows a smectic D phase.

### (Medium—Example 2)

The medium A may be a liquid crystal microemulsion. Here, the liquid crystal microemulsion is a generic term referring to a system (mixed system) proposed in non-patent document 3 (Liquid Crystal Microemulsion by YAMAMOTO Jun, Liquid Crystal, Vo. 4, No. 3, pp. 248-254, (2000)). The system is an O/W microemulsion (a system where water is dissolved in an oil using a surfactant so that the water forms water drops; the oil is in a continuous phase) with its oil molecules being replaced by thermotropic liquid crystal molecules.

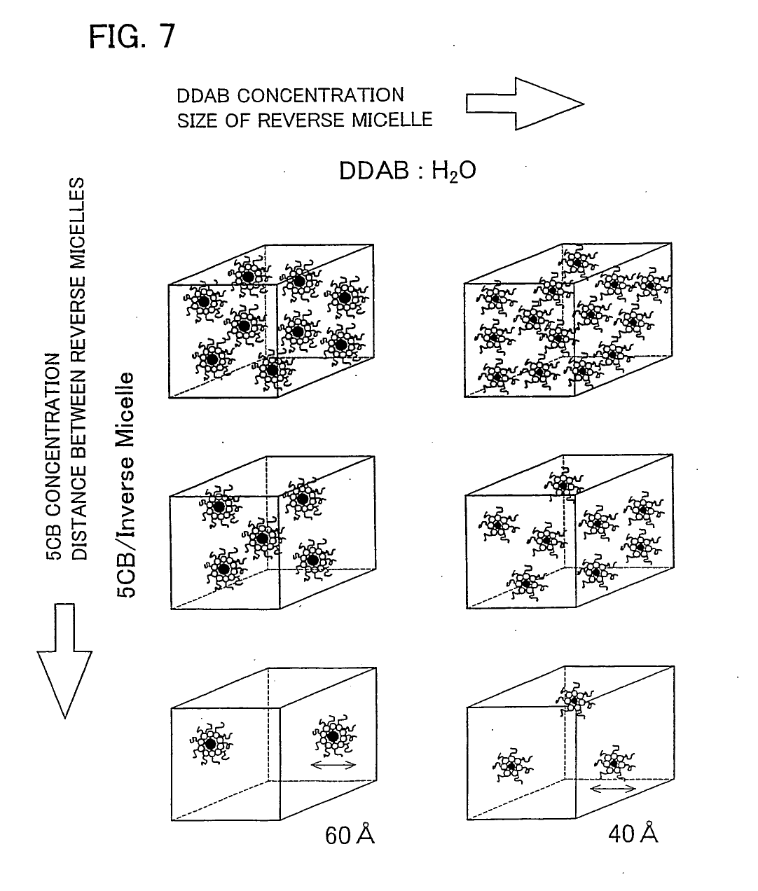

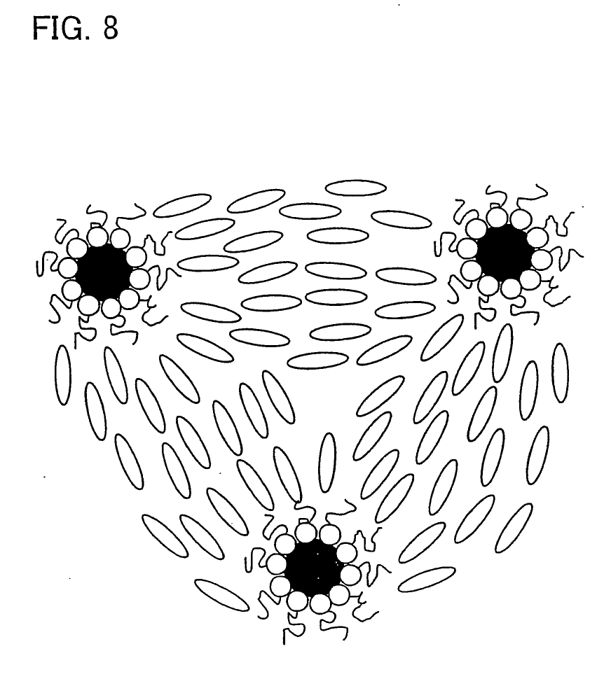

A specific example of such a liquid crystal microemulsion is a mixed system of pentylcyanobiphenyl (5CB) and an aqueous solution of didodecyl ammonium bromide (DDAB). The former is a thermotropic liquid crystal showing a nematic liquid crystal phase and described in non-patent document 3. The latter is a lyotropic liquid crystal showing a reverse micelle phase. The mixed system has a structure shown schematically in FIG. 7 and FIG. 8.

A reverse micelle of the mixed system measures typically about 50 angstroms in diameter. The distance separating reverse micelles is about 200 angstroms. These figures are about one order of magnitude less than optical wavelengths. Reverse micelles are positioned randomly in a three-dimensional space. 5CB molecules align to radiate out from each reverse micelle in the center. Therefore, the mixed system exhibits optical isotropy.

5CB molecules have dielectric anisotropy. Therefore, in an electric field, the molecules of a medium of the mixed system experience forces parallel to the electric field. In other words, the system, which was optically isotropic because of the radiating alignment from the reverse micelle, now exhibits alignment anisotropy, hence optical anisotropy. Thus, the mixed system can be used as the medium A in the present display element. The medium A is by no means limited to the mixed system. Any liquid crystal microemulsion may be used as the medium A in the present display element, provided that the microemulsion is optically isotropic in the absence of applied voltage and exhibits optical anisotropy under applied voltage.

### (Medium—Example 3)

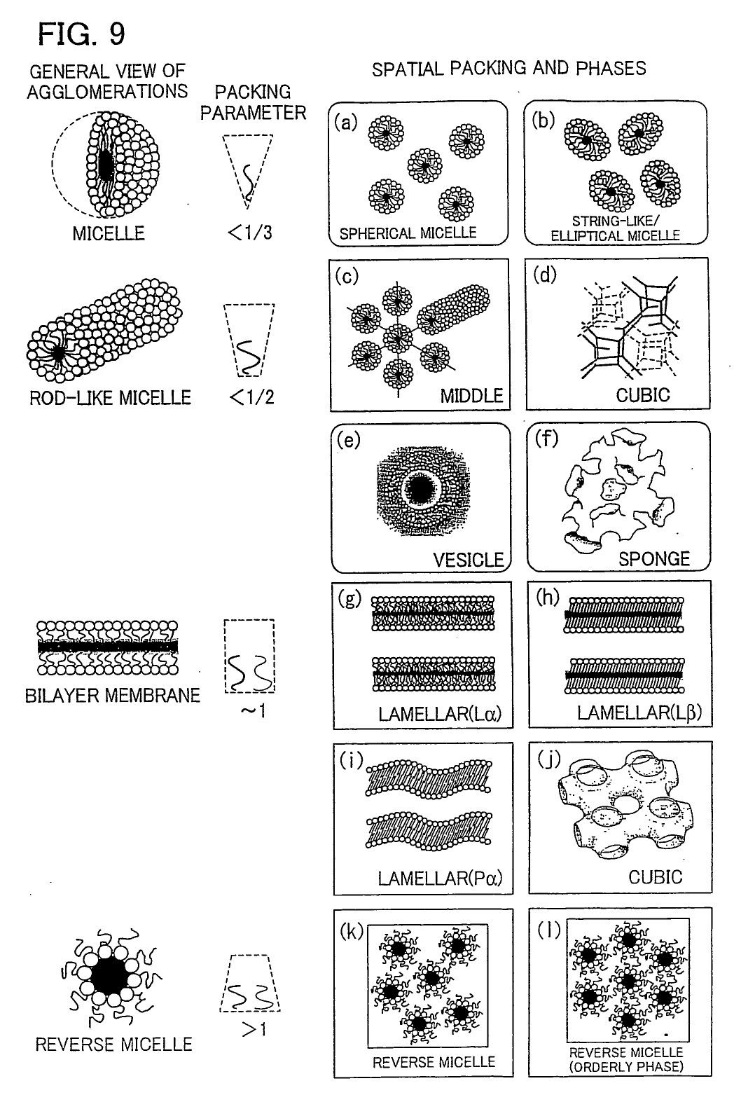

The medium A may be a lyotropic liquid crystal showing a particular phase. The lyotropic liquid crystal refers to a multicomponent liquid crystal in which major molecules comprising the liquid crystal are dissolved in a solvent of a different nature (e.g., water, an organic solvents). The particular phase refers to one in which optical isotropy occurs in the absence of an electric field. Non-patent document 5 (Liquid Crystal Science Experiment Lecture 1, Identification of Liquid Crystal Phase, (4) Lyotropic Liquid Crystal, by YAMAMOTO Jun, Liquid Crystal, Vo. 6, No. 1, pp. 72-82) describes examples of the particular phase: micelle phase, sponge phase, cubic phase, and reverse micelle phase. FIG. 9 shows a classification of the lyotropic liquid crystal phases.

Some surfactants, which are amphiphilic, show a micelle phase. For example, an aqueous solution of sodium dodecyl sulfate which is an ionic surfactant forms spherical micelles. So does an aqueous solution of potassium palmitate. Also, in a liquid mixture of water and polyoxyethylene nonylphenylether, which is a non-ionic surfactant, a nonylphenyl group acts as a hydrophobic group, and an oxyethylene chain as a hydrophilic group. The action forms micelles. An aqueous solution of a styrene-ethyleneoxide block copolymer forms micelles too.

For example, in a spherical micelle, molecules are packed in all directions in a space (form molecule clusters) to give it a spherical shape. The spherical micelle, measuring less than or equal to optical wavelengths, appears isotropic, not anisotropic, at optical wavelengths. However, upon the application of an electric field, the spherical micelle is distorted and exhibits anisotropy. Thus, the lyotropic liquid crystal showing a spherical micelle phase can be used as the medium A in the present display element. The medium A is not limited to the spherical micelle phase. The micelle phase of any other shape, including a string, elliptical, or rod shape, may be used as the medium A and, successfully producing substantially similar effects.

It is generally known that a reverse micelle in which the hydrophilic group and the hydrophobic group are reversed can be formed depending on concentration, temperature, and the surfactant's conditions. Optically, reverse micelles produce similar effects to micelles. Therefore, a reverse micelle phase used as the medium A produces similar effects to a micelle phase. The “Medium—example 2” liquid crystal microemulsion is an example of the lyotropic liquid crystal showing a reverse micelle phase (reverse micelle structure).

An aqueous solution of pentaethyleneglycol-dodecylether (C12E5), which is a non-ionic surfactant, shows a sponge phase and a cubic phase (see FIG. 9) at certain concentrations and temperatures. The sponge and cubic phases, having an order less than or equal to optical wavelengths, are transparent at optical wavelengths. In other words, a medium of these phases are optically isotropic, and upon the application of voltage, changes in orientational order and exhibits optical anisotropy. Thus, the lyotropic liquid crystal showing the sponge and cubic phases can be used as the medium A in the present display element.

### (Medium—Example 4)

The medium A in the present display element may be a liquid crystal fine particle dispersion system which exhibits such a phase where optical isotropy changes depending on the presence/absence of an applied electric field. Examples of such a phase include a micelle phase, sponge phase, cubic phase, and reverse micelle phase. Here, the liquid crystal fine particle dispersion system refers to a mixed system containing fine particles mixed in a solvent.

An example of the liquid crystal fine particle dispersion system is one containing latex particles (about 100 angstroms in diameter) mixed in an aqueous solution of pentaethyleneglycol-dodecylether (C12E5), which is a non-ionic surfactant, the surface of the particles being modified with a sulfate group. The liquid crystal fine particle dispersion system exhibits a sponge phase, and can be therefore used as the medium A in the present display element as in “Medium—example 3”. With the latex particles being replaced with DDAB, the liquid crystal fine particle dispersion system creates a similar aligned structure to the “Medium—example 2” liquid crystal microemulsion. DDAB was described in connection with the “Medium—example 2” liquid crystal microemulsion.

### (Medium—Example 5)

The medium A in the present display element may be a dendrimer. Here, the dendrimer refers to a three-dimensional, highly branched polymer with each monomer unit having a branch.

The dendrimer is highly branched, and therefore assumes a spherical structure above a certain molecular weight. The spherical structure, having an order less than or equal to optical wavelengths, is transparent at optical wavelengths. Upon the application of voltage, the orientational order changes, and optical anisotropy occurs. Therefore, the dendrimer can be used as the medium A in the present display element.

Replacing DDAB in the “Medium—example 2” liquid crystal microemulsion with the dendrimer substance, an aligned structure is created which is similar to the “Medium—example 2” liquid crystal microemulsion. The structure can be used as the medium A in the present display element.

### (Medium—example 6)

The medium A in the present display element may be a cholesteric blue phase. FIG. 9 schematically shows the structure of a cholesteric blue phase.

As shown in FIG. 9, the cholesteric blue phase contains a highly symmetric structure. The cholesteric blue phase, having an order less than or equal to optical wavelengths, is almost transparent at optical wavelengths. Upon the application of voltage, the orientational order changes, and optical anisotropy occurs. In other words, the cholesteric blue phase is substantially optically isotropic. In an applied electric field, the liquid crystal molecules experience forces parallel to the electric field, distorting the lattice. The distortion causes anisotropy. Thus, the cholesteric blue phase can be used as the medium A in the present display element.

An example of a cholesteric blue phase substance is a mixture containing 48.2% JC 1041 (mixed liquid crystal, available from Chisso Corp.), 47.4% 5CB (4-cyano-4′-pentyl biphenyl; nematic liquid crystal), and 4.4% ZLI-4572 (chiral dopant, available from Merck & Co.). The substance shows a cholesteric blue phase from 330.7 K to 331.8 K.

### (Medium—example 7)

The medium A of the present display element may be a smectic blue (BP_{Sm}) phase. FIG. 9 schematically shows the structure of a smectic blue phase.

As shown in FIG. 9, the smectic blue phase contains a highly symmetric structure as with the cholesteric blue phase. The smectic blue phase, having an order less than or equal to optical wavelengths, is almost transparent substance at optical wavelengths. Upon the application of voltage, the orientational order changes, and optical anisotropy occurs. In other words, the smectic blue phase is substantially optically isotropic. In an applied electric field, the liquid crystal molecules experience forces parallel to the electric field, distorting the lattice. The distortion causes anisotropy. Thus, the smectic blue phase can be used as the medium A in the present display element.

An example of a smectic blue phase substance is FH/FH/HH-14BTMHC described in non-patent document 6 (Structural Investigations on Smectic Blue Phases by Eric Grelet and three others, Physical Review Letters, the American Physical Society, 23 Apr. 2001, Vol. 86, No. 17, pp. 3791-3794). The substance exhibits a BP_{Sm}3 phase from 74.4° C. to 73.2° C., a BP_{Sm}2 phase from 73.2° C. to 72.3° C., and a BP_{Sm}1 phase from 72.3° C. to 72.1° C.

Here, the BP_{Sm} phases contains a highly symmetric structure. Hence, the phases are substantially optically isotropic. See non-patent document 7 (Studies on Nanostructural Liquid Crystal Phases by Molecule Simulation by YONEYA Makoto, Liquid Crystal, Vol. 7, No. 3, pp. 238-245), especially FIG. 1 on page 238. In an applied electric field, FH/FH/HH-14BTMHC experiences forces parallel to the electric field, distorting the lattice. The distortion causes the substance to exhibit anisotropy. Thus, the substance can be used as the medium A in the display element in accordance with the present embodiment.

As described in the foregoing, a display apparatus of the present invention includes display elements provided with a medium injected and sealed between a pair of substrates at least one of which is transparent. The medium changes in magnitude of optical anisotropy upon application of voltage. Each of the display elements contains colors required to produce a color image display, so as to produce a color image display. Different voltages are applied to the display elements so as to display the colors required to produce a color image display with an identical gradation.

According to the arrangement, voltages can be applied to the display elements in accordance with the wavelength dispersion characteristic of the optical anisotropy. The color discrepancies are thus limited.

Especially, the medium only changes in magnitude of optical anisotropy. The relationship between the application voltage and transmittance of the display element practically matches up for two cases: i.e., when the display element is viewed normal to the substrate and when the display element is viewed from an acute angle with respect to the normal. Therefore, in both cases, color discrepancies are limited, and colors are accurately displayed.

Further, in the display apparatus thus arranged, it is preferable if the voltages applied are determined based on a lookup table which associates gradations of an image displayed by the display apparatus with the voltages applied to the display elements.

According to the arrangement, merely storing the lookup table in a ROM or like storage medium allows reference to the lookup table. This in turn enables the determination of the voltages applied to the display elements so that the voltages applied can limit color discrepancies. Thus, it is possible to provide a display apparatus with its color discrepancies being eased at low cost.

The medium may be chosen from those which are optically isotropic in the absence of an electric field and exhibit optical anisotropy under applied voltage. Alternatively, the medium may be chosen from those which are optically anisotropic in the absence of an electric field and exhibit optical isotropy under applied voltage.

In either type of medium, a display element can be obtained which differs in display state depending on the presence/absence of applied voltage. The element also boasts a wide operating temperature range, wide viewing angle, and quick response.

It is preferable if the medium has an ordered structure less than optical wavelengths either under applied voltage or in the absence of applied voltage. If the ordered structure is less than optical wavelengths, the medium exhibits optical isotropy. The use of the medium of which the ordered structure become less than optical wavelengths either under applied voltage or in the absence of applied voltage renders it possible to reliably produce different display states in the absence of applied voltage and under applied voltage.

The medium may be chosen from those which have an ordered structure showing cubic symmetry.

The medium may be comprised by molecules showing a cubic phase or a smectic D phase.

The medium may be comprised by a liquid crystal microemulsion. The medium may be comprised by a lyotropic liquid crystal showing any one of a micelle phase, a reverse micelle phase, a sponge phase, and a cubic phase.

The medium may be comprised by a liquid crystal fine particle dispersion system showing any one of a micelle phase, a reverse micelle phase, a sponge phase, and a cubic phase.

The medium may be a dendrimer.

The medium may be comprised by molecules showing a cholesteric blue phase.

The medium may be comprised by molecules showing a smectic blue phase.

The above-listed substances change in optical anisotropy upon the application of an electric field. Therefore, these substances can be used as the medium injected and sealed in the dielectric liquid layer in the display element of the present invention.

Alternatively, the display element of the present invention may be arranged as follows. At least one of the pair of substrates has multiple electrodes. An electric field is produced between the electrodes to apply the electric field across the medium. In another arrangement, both substrates have an electrode. An electric field is produced between the electrodes on the substrates to apply the electric field across the medium.

In either arrangement, it is possible to apply an electric field across the medium, hence change the optical anisotropy of the medium.

Alternatively, the display apparatus of the present invention may include display elements provided with a medium injected and sealed between a pair of substrates at least one of which is transparent. The optical anisotropy of the medium changes in a substantially constant direction in the substrate plane upon the application of voltage. Each of the display elements contains colors required to produce a color image display, so as to produce a color image display. Different voltages are applied to the display elements so as to display the colors required to produce a color image display with an identical gradation.

In the arrangement, when colors required to produce a color image display need to be displayed with an identical gradation, different voltages are applied to the display elements. Therefore, voltages can be applied to display elements in accordance with the wavelength dispersion characteristic of the optical anisotropy. The color discrepancies can be thus limited.

Especially, the medium only changes its optical anisotropy in a substantially constant direction in the substrate plane. The application voltage vs. transmittance relationship of the display element practically matches up for two cases: i.e., when the display element is viewed normal to the substrate and when the display element is viewed from an acute angle with respect to the normal. Therefore, in both cases, color discrepancies are limited.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and the scope of the invention as hereinafter claimed.

### INDUSTRIAL APPLICABILITY

According to the present invention, accurate colors can be reproduced in both cases: i.e., when the display apparatus is viewed from the normal and when it is viewed from an oblique angle. Therefore, it is ensured that the color reproducibility of the display apparatus in information terminals including television sets, word processors, personal computers, video cameras, digital cameras, and mobile phones will be improved.

1. A display apparatus, comprising display elements including a medium injected and sealed between a pair of substrates at least one of which is transparent,
the medium changing in magnitude of optical anisotropy upon application of voltage,
each of the display elements containing colors required to produce a color image display, so as to produce a color image display,
different voltages being applied to the display elements so as to display the colors required to produce a color image display with an identical gradation.

2. The display apparatus as set forth in claim 1, wherein the voltages applied are determined based on a lookup table which associates gradations of an image displayed by the display apparatus with the voltages applied to the display elements.

3. The display apparatus as set forth in claim 1, wherein the colors required to produce a color image display are three colors of RGB.

4. The display apparatus as set forth in claim 1, wherein the medium exhibits optical isotropy in absence of an electric field and exhibits optical anisotropy under applied voltage.

5. The display apparatus as set forth in claim 1, wherein the medium exhibits optical anisotropy in absence of an electric field and exhibits optical isotropy under applied voltage.

6. The display apparatus as set forth in claim 1, wherein the medium is comprised by molecules having an ordered structure less than optical wavelengths either under applied voltage or in absence of applied voltage.

7. The display apparatus as set forth in claim 1, wherein the medium has an ordered structure showing cubic symmetry.

8. The display apparatus as set forth in claim 1, wherein the medium is comprised by molecules showing a cubic phase or a smectic D phase.

9. The display apparatus as set forth in claim 1, wherein the medium is comprised by a liquid crystal microemulsion.

10. The display apparatus as set forth in claim 1, wherein the medium is comprised by a lyotropic liquid crystal showing any one of a micelle phase, a reverse micelle phase, a sponge phase, and a cubic phase.

11. The display apparatus as set forth in claim 1, wherein the medium is comprised by a liquid crystal fine particle dispersion system showing any one of a micelle phase, a reverse micelle phase, a sponge phase, and a cubic phase.

12. The display apparatus as set forth in claim 1, wherein the medium is comprised by a dendrimer.

13. The display apparatus as set forth in claim 1, wherein the medium is comprised by molecules showing a cholesteric blue phase.

14. The display apparatus as set forth in claim 1, wherein the medium is comprised by molecules showing a smectic blue phase.

15. A display element in a display apparatus,
each display element containing colors required to produce a color image display, so as to produce a color image display,
different voltages being applied to the display elements so as to display the colors required to produce a color image display with an identical gradation,
a medium being injected and sealed between a pair of substrates at least one of which is transparent, the medium changing in magnitude of optical anisotropy upon application of voltage.
